(19) United States
(12) Patent Application Publication
(10) Pub. No.: US 2004/0127212 A1
(43) Pub. Date: Jul. 1, 2004

(54) Apparatus, system and method for network testing

(76) Inventor: Jian Chung Wang, Tu-Chen (TW)

Correspondence Address: WEI TE CHUNG, FOXCONN INTERNATIONAL, INC., 1650 MEMOREX DRIVE, SANTA CLARA, CA, 95050, US

(21) Appl. No.: 10/640,346

(22) Filed: Aug. 12, 2003

(30) Foreign Application Priority Data
Dec. 27, 2002 (TW) 91137598

(51) Int. Cl. H04Q 7/20

(52) U.S. Cl. 455/423

(57) ABSTRACT

A network testing system for performing network simulation tests and traffic tests comprises an administrative workstation (2), a network testing apparatus (6) and a network device (8). The administrative workstation comprises a simulation test controlling module (24), a traffic generating parameter designing module (26), and a network model designing module (22). When the network testing apparatus is in a network simulating test mode, the simulation test controlling module is for transmitting simulation test parameters. The network testing apparatus is for selecting a network simulating model and a network protocol, and for controlling traffic generation to perform network simulation tests. When the network testing apparatus is in a traffic generator operating mode, the traffic generating parameter designing module is for transmitting the second traffic generating parameters. The network testing apparatus is for controlling traffic generation to perform traffic tests. A network testing method is also disclosed.

### BACKGROUND OF THE INVENTION

1. Field of the Invention

The present invention relates to a network testing apparatus, system and method, and particularly to an apparatus, system and method for performing network simulation tests and traffic tests.

2. Background Information

With the rapid development of the Internet, communication networks are becoming larger and larger, and network applications are becoming more and more complicated. These factors provide many new challenges for network designers. Current issues include packet switching, conventional network design theories, present network design methods, and the variety of available networking technologies. Conventional network design theory based on mathematical computations does not necessarily meet actual needs. Contemporary network design methods based on experience in the field are suitable for designing small and medium-sized networks. However, with the rapid extension and expansion of modern networks, network designing is becoming more and more complicated. Consequently, factors that should be taken into account in the design of a network are increasing rapidly, and often go beyond the range of human experience. The wide variety of network technologies available also increases investment risks. There are often many technologies and competing products available for solving questions in the field of network communications. Investment risks are increased if investors depend only on reports provided by manufacturers at the stage of network designing. If network traffic and performance can be assessed at the time of network design, the structure of the network can be optimized, and the cost of network reduced. Therefore in network design, it is generally necessary to test networks themselves as well as network devices.

In conventional network testing, it is necessary to build a physical network environment that needs be tested. FIG. 6 is a schematic diagram of an application environment of a conventional network testing system. A network device 8 to be tested should be connected with a plurality of network devices 9 directly or through a network. This provides a network testing system with a real application environment for performing tests on the network device 8. However, it takes considerable time and manpower and many devices to build the physical application environment needed to perform such testing.

In a conventional network or network device test, a traffic generator is used as an independent network testing device. The traffic generator can generate packets according to defined conditions, in order to simulate a variety of network devices such as switches or routers. The traffic generator can also generate actual traffic to test the performance of destination devices such as switches or routers, or to test a network. For example, when testing a switch, the traffic generator generates packets and transmits them to the switch. The traffic generator generates inbound traffic in the form of inbound packets transmitted to the switch, and monitors and analyzes outbound traffic in the form of outbound packets transmitted by the switch. The traffic generator can thus evaluate the performance of the switch. One important factor in determining the performance of the traffic generator itself is whether a plurality of communication ports of the traffic generator can generate linear-rated traffic in different environments. If the traffic generator meets this requirement, it is typically very expensive, with the price generally being between $10,000 and $1,000,000 or more. Yet in many tests on a switch, especially tests on the functions of a switch, only a few communication ports of the traffic generator are needed to generate linear-rated or nonlinear-rated traffic.

### SUMMARY OF THE INVENTION

Accordingly, an object of the present invention is to provide a network testing apparatus that can be implemented in two alternative modes, the modes being a network simulating test mode and a traffic generator operating mode.

Another object of the present invention is to provide a network testing system for implementing network simulation tests and traffic tests.

A further object of the present invention is to provide a network testing method for performing network simulation tests and traffic tests by using a network testing apparatus.

To achieve the first above-mentioned object, a network testing apparatus according to the present invention can be operated in either of two modes: a network simulating test mode or a traffic generator operating mode. The network testing apparatus comprises a software module, a hardware module, and a plurality of communication ports. The software module comprises a network simulating database for storing a plurality of network simulating models, a network protocol database for storing a plurality of network protocols, a simulation processing module, and a traffic generation controlling module. The hardware module comprises a traffic generating apparatus and a media access control (MAC). Wherein when the network testing apparatus is in the network simulating test mode, the simulation processing module is for selecting a network simulating model and a network protocol, and for generating a first traffic generating command to control traffic generation of the traffic generating apparatus. When the network testing apparatus is in the traffic generator operating mode, the traffic generation controlling module is for generating a second traffic generating command to control traffic generation of the traffic generating apparatus. The traffic generating apparatus is for generating traffic according to the first traffic generating command or the second traffic generating command. The MAC is for transmitting the generated traffic to a corresponding communication port.

To achieve the second above-mentioned object, a network testing system according to the present invention performs network simulation tests and traffic tests. The network testing system comprises an administrative workstation, a network testing apparatus as described above, and a network device. The administrative workstation comprises a network model designing module for designing the network simulating model, a simulation test controlling module, and a traffic generating parameter designing module. The network device is connected to the network testing apparatus.

When the network testing apparatus is in the network simulating test mode, the simulation test controlling module is for selecting simulation test parameters, and for transmitting the simulation test parameters to the network testing apparatus. The simulation processing module is for receiving the simulation test parameters, and for selecting a network simulating model and a network protocol according to the simulation test parameters, and for generating the first traffic generating command to control traffic generation of the traffic generating apparatus for performing network simulation tests.

When the network testing apparatus is in the traffic generator operating mode, the traffic generating parameter designing module is for inputting the second traffic generating parameters, and for transmitting the second traffic generating parameters to the network testing apparatus. The traffic generation controlling module is for receiving the second traffic generating parameters, and for generating the second traffic generating command to control traffic generation of the traffic generating apparatus for performing traffic tests according to the second traffic generating parameters.

To achieve the third above-mentioned object, a network testing method according to the present invention performs network simulation tests and traffic tests by using the above-described network testing apparatus. The method comprises the steps of: a) setting the network testing apparatus in the network simulating test mode or the traffic generator operating mode; b) when the network testing apparatus is set in network simulating test mode, comprising the following steps: b1) designing the network simulating model, the network model designing module of the administrative workstation transmitting the designed network simulating model to the network testing apparatus, and the network testing apparatus storing the network simulating model into the network simulating database; b2) setting simulation test parameters, the simulation test controlling module of the administrative workstation transmitting the simulation test parameters to the network test apparatus; b3) receiving the simulation test parameters, the simulation processing module of the network testing apparatus selecting a network simulating model and a network protocol according to the simulation test parameters, and controlling traffic generation to perform network simulation tests; c) when the network testing apparatus is set in traffic generator operating mode, comprising the following steps: c1) setting the second traffic generating parameters in the traffic generating parameter designing module of the administrative workstation; c2) receiving the second traffic generating parameters, the traffic generation controlling module of the network testing apparatus controlling traffic generation to perform traffic tests according to the second traffic generating parameters.

Using the said network testing apparatus, system and method in network simulation tests and traffic tests enables network tests to be conveniently performed. In particular, the number of network devices can be reduced, as can time and manpower expended.

Further novel features and other advantages of the present invention will be drawn from the following detailed description of preferred embodiments of the present invention with the attached drawings, in which:

### BRIEF DESCRIPTION OF THE DRAWINGS

FIG. 1 is a schematic diagram of an application environment of a network testing system according to the present invention;

FIG. 2 is a schematic diagram of infrastructure of a network testing apparatus according to the present invention;

FIG. 3 is a block diagram of a network testing system according to the present invention;

FIG. 4 is a flow chart of a method of network simulation testing according to the present invention;

FIG. 5 is a flow chart of a method of traffic testing according to the present invention; and

FIG. 6 is a schematic diagram of an application environment of a conventional network testing system.

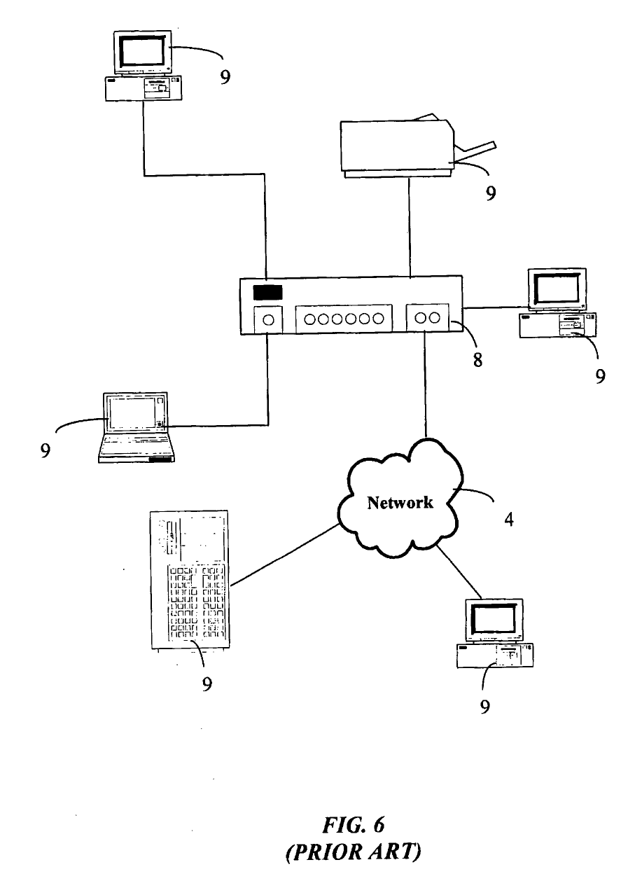

### DETAILED DESCRIPTION OF THE PREFERRED EMBODIMENTS

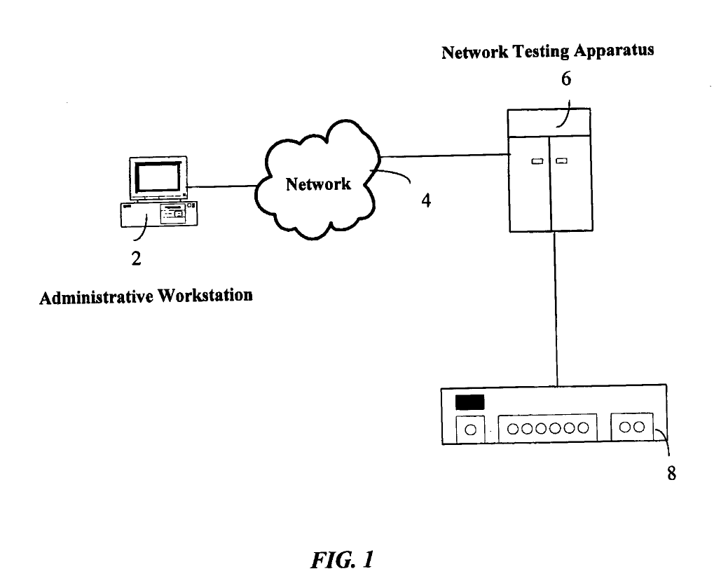

FIG. 1 is a schematic diagram of an application environment of a network testing system according to the present invention. In a preferred embodiment of the present invention, an administrative workstation 2 is connected to a network testing apparatus 6 through a network 4. In an alternative embodiment, the administrative workstation 2 is connected to the network testing apparatus 6 directly. The network testing apparatus 6 is connected with a network device 8 to be tested. The network testing apparatus 6 can be operated in either of two modes: a network simulating test mode or a traffic generator operating mode. The default mode is the network simulating test mode. A user can set the network testing apparatus 6 in a desired one of the two modes through a user interface (not shown). The user controls the network testing apparatus 6 to perform network simulation tests and traffic tests on the network device 8 by use of the administrative workstation 2.

The network 4 can be an Intranet or the Internet, and the network device 8 can be a switch, a router, a server, a network printer, a network electrograph, an uninterruptable power supply (UPS) or the like.

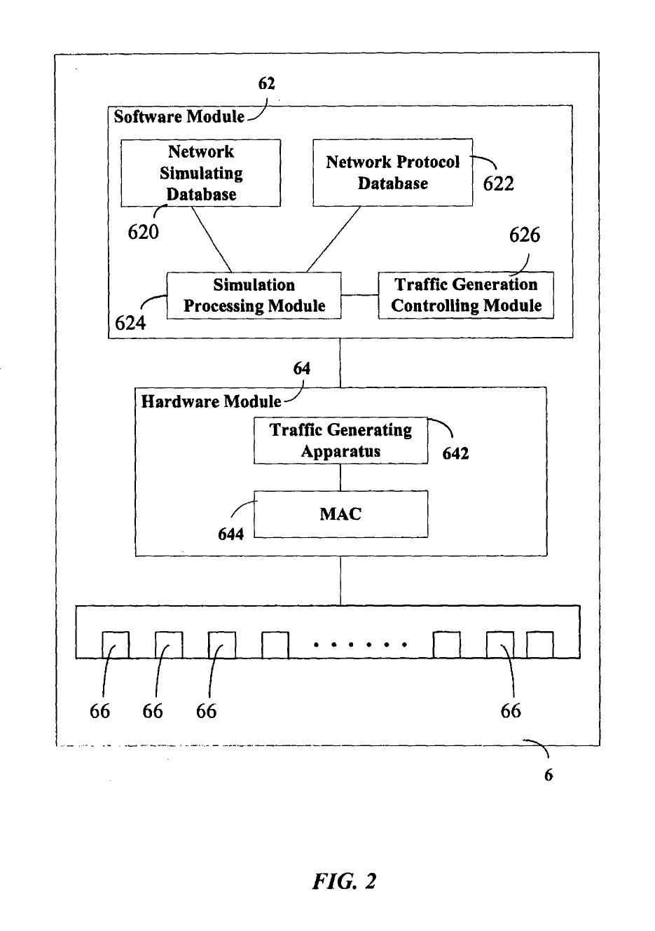

FIG. 2 is a schematic diagram of infrastructure of the network testing apparatus 6. When in the network simulating test mode, the network testing apparatus 6 selects a network simulating model and a network protocol, and controls traffic generation to perform network simulation tests on the network device 8 (see FIG. 1). When in the traffic generator operating mode, the network testing apparatus 6 generates traffic to perform traffic tests on the network device 8.

The network testing apparatus 6 comprises a software module 62, a hardware module 64, and a plurality of communication ports 66. The software module 62 comprises a network simulating database 620, a network protocol database 622, a simulation processing module 624, and a traffic generation controlling module 626. The network simulating database 620 is a database for storing network simulating models. The network protocol database 622 is a database for storing network protocols. The simulation processing module 624 is used for accessing the network simulating database 620 and the network protocol database 622 to obtain a network model and a network protocol, and for generating a first traffic generating command to control traffic generation of the hardware module 64.

When the network testing apparatus 6 is in the traffic generator operating mode, the traffic generation controlling module 626 generates a second traffic generating command to control traffic generation of the hardware module 64. The traffic generation controlling module 626 also performs traffic control, traffic rate and distribution control, packet content and length control, and packet transmission/receipt statistics.

The hardware module 64 in the network testing apparatus 6 is an application specific integrated circuit (ASIC), which comprises a traffic generating apparatus 642 and a media access control (MAC) 644. When the network testing apparatus 6 is in the traffic generator operating mode, the traffic generating apparatus 642 generates traffic with a predetermined traffic rate and packet content and length, according to the second traffic generating command generated by the traffic generation controlling module 626. The traffic generating apparatus 642 transmits the generated traffic to the network device 8 to test the performance of the network device 8. Performance criteria include switching capacity, backplane bandwidth, processing capability, throughput, and so on. When the network testing apparatus 6 is in the network simulating test mode, the traffic generating apparatus 642 generates the traffic with a predetermined traffic rate and packet content and length, according to the first traffic generating command generated by the simulation processing module 624. The traffic generating apparatus 642 transmits the generated traffic to the network device 8 to perform simulation tests on the network device 8.

Each communication port 66 can be connected with all kinds of network devices 8, such as workstations, terminals, servers, routers and so on. Via the communication ports 66, the network testing apparatus 6 communicates with other network devices 8 to perform network simulation tests and traffic tests on the network devices 8.

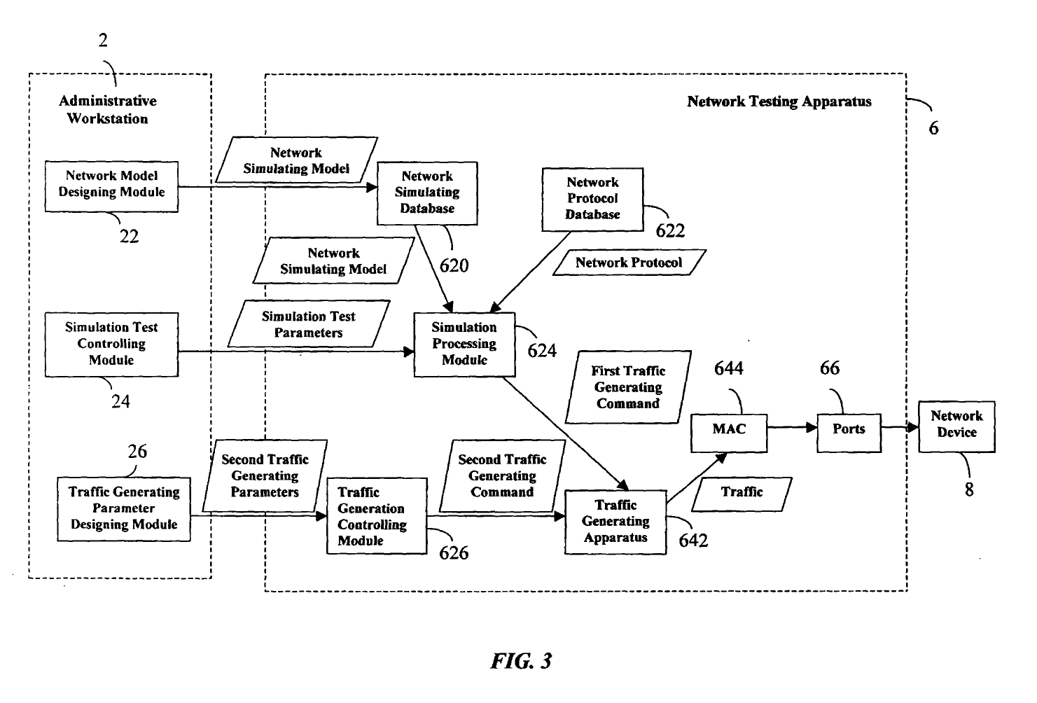

FIG. 3 is a block diagram of a network testing system according to the present invention. The network testing system comprises one administrative workstation 2, one network testing apparatus 6, and one network device 8 connected to the network testing apparatus 6. The administrative workstation 2 comprises a network model designing module 22, a simulation test controlling module 24, and a traffic generating parameter designing module 26. The network testing apparatus 6 comprises the network simulating database 620, the network protocol database 622, the simulation processing module 624, the traffic generation controlling module 626, the traffic generating apparatus 642, the media access control (MAC) 644, and the plurality of communication ports 66 (only one shown).

When the network testing apparatus 6 is in the network simulating test mode, a user uses the network model designing module 22 to set up a network simulating model and simulate an actual network environment. When the network simulating model is set up, the administrative workstation 2 transmits the network simulating model to the network testing apparatus 6. The network testing apparatus 6 stores the network simulating model in the network simulating database 620. During a network simulation test, the user selects simulation test parameters by use of the simulation test controlling module 24. The simulation test parameters comprise the network simulating model, the network protocol, and the first traffic generating parameters. The first traffic generating parameters comprise traffic rate, packet content and length, and traffic transmission time. The traffic transmission time is the length of time taken for traffic to be transmitted. The administrative workstation 2 transmits the simulation test parameters to the network testing apparatus 6. The simulation processing module 624 of the network testing apparatus 6 receives the simulation test parameters, accesses the network simulating database 620 and the network protocol database 622 to obtain the network model and the network protocol defined by the simulation test parameters, and generates a first traffic generating command according to the first traffic generating parameters. The traffic generating apparatus 642 generates traffic with a predetermined traffic rate and packet content and length according to the first traffic generating command, and transmits the generated traffic to the network device 8 through the MAC 644 to perform network simulation tests.

When the network testing apparatus 6 is in the traffic generator operating mode, the user can input the second traffic generating parameters through a user interface (not shown) provided by the traffic generating parameter designing module 26. The second traffic generating parameters comprise traffic rate, packet content and length, and traffic transmission time. The network testing apparatus 6 receives the second traffic generating parameters, and generates a second traffic generating command based on the second traffic generating parameters. According to the second traffic generating command, the traffic generating apparatus 642 generates traffic with a predetermined traffic rate and packet content and length, and transmits the generated traffic to the network device 8 through the MAC 644 to test the performance of the network device 8.

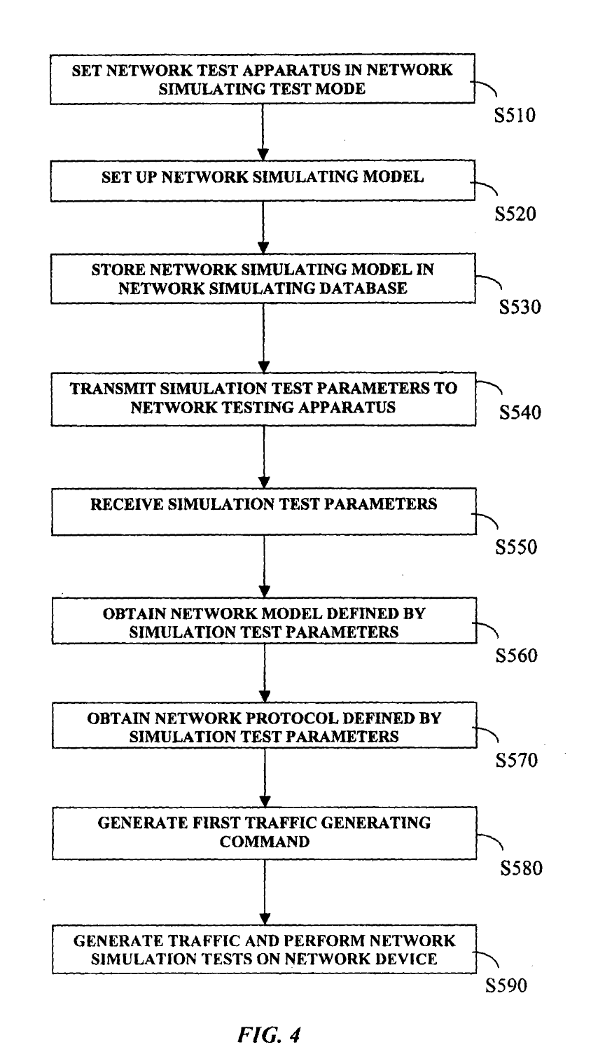

FIG. 4 is a flow chart of a method of network simulation testing according to the present invention. At step S510, a user sets the network testing apparatus 6 in the network simulating test mode. At step S520, the user sets up a network simulating model through the network model designing module 22 of the administrative workstation 2. The network simulating model is used for simulating an actual network environment. The administrative workstation 2 transmits the network simulating model to the network testing apparatus 6. At step S530, the network testing apparatus 6 stores the network simulating model in the network simulating database 620. When performing network simulation tests, the user sets simulation test parameters through the simulation test controlling module 24. Such parameters include the network simulating model, the network protocol, the first traffic generating parameters that control traffic generation in the process of network simulation testing, and so on. At step S540, the administrative workstation 2 transmits the simulation test parameters to the network testing apparatus 6. At step S550, the simulation processing module 624 of the network testing apparatus 6 receives the simulation test parameters. At step S560, the simulation processing module 624 accesses the network simulating database 620 to obtain the network model defined by the simulation test parameters. At step S570, the simulation processing module 624 accesses the network protocol database 622 to obtain the network protocol defined by the simulation test parameters. At step S580, according to the first traffic generating parameters of the simulation test parameters, the simulation processing module 624 generates a first traffic generating command. At step S590, according to the first traffic generating command, the traffic generating apparatus 642 generates traffic with a predetermined traffic rate and packet content and length, and transmits the generated traffic to the network device 8 through the MAC 644 to perform network simulation tests.

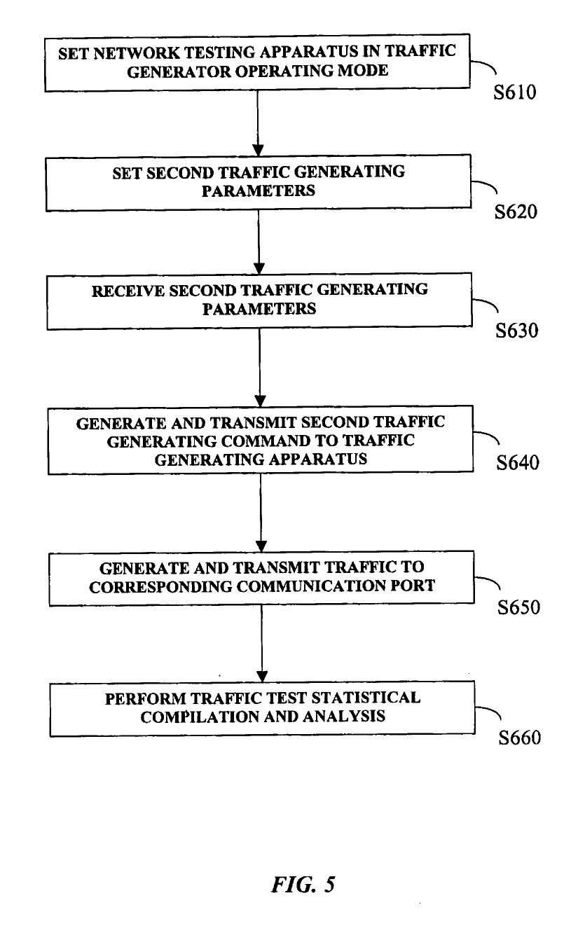

FIG. 5 is a flow chart of a method of traffic testing according to the present invention. At step S610, a user sets the network testing apparatus 6 (see FIG. 3) in the traffic generator operating mode. At step S620, the user sets the second traffic generating parameters through the traffic generating parameter designing module 26. At step S630, the administrative workstation 2 transmits the second traffic generating parameters to the network testing apparatus 6, and the traffic generation controlling module 626 of the network testing apparatus 6 receives the second traffic generating parameters. At step S640, the traffic generation controlling module 626 generates a second traffic generating command according to the second traffic generating parameters, and transmits the generated second traffic generating command to the traffic generating apparatus 642. At step S650, the traffic generating apparatus 642 generates traffic with a predetermined traffic rate and packet content and length according to the second traffic generating command, and transmits the generated traffic to a corresponding communication port 66 through the MAC 644. At step S660, the traffic generation controlling module 626 performs traffic test statistical compilation and analysis on the network device 8. For example, the traffic generation controlling module 626 may collect the packets received and transmitted by the network device 8.

While preferred embodiments of the present invention have been described above, it should be understood that they been presented by way of example only and not by way of limitation. Thus the breadth and scope of the present invention should not be limited by the above-described exemplary embodiments, but should be defined only in accordance with the following claims and their equivalents.

What is claimed is:

1. A network testing apparatus for performing network simulation tests and traffic tests in alternative modes, the network testing apparatus comprising:
a software module, comprising:
a network simulating database for storing a plurality of network simulating models;
a network protocol database for storing a plurality of network protocols;
a simulation processing module; and
a traffic generation controlling module;
a hardware module, comprising:
a traffic generating apparatus; and
a media access control; and
a plurality of communication ports.

2. The network testing apparatus of claim 1, wherein the network testing apparatus is operated in either of two modes: a network simulating test mode or a traffic generator operating mode.

3. The network testing apparatus of claim 2, wherein when the network testing apparatus is in the network simulating test mode, the simulation processing module is used for selecting a network simulating model and a network protocol, and for generating a first traffic generating command to control traffic generation of the traffic generating apparatus.

4. The network testing apparatus of claim 3, wherein the traffic generating apparatus is used for generating traffic according to the first traffic generating command.

5. The network testing apparatus of claim 4, wherein the media access control is used for transmitting the generated traffic to a corresponding communication port.

6. The network testing apparatus of claim 2, wherein when the network testing apparatus is in the traffic generator operating mode, the traffic generation controlling module is used for generating a second traffic generating command to control traffic generation of the traffic generating apparatus.

7. The network testing apparatus of claim 6, wherein the traffic generating apparatus is used for generating traffic according to the second traffic generating command.

8. The network testing apparatus of claim 7, wherein the media access control is used for transmitting the generated traffic to a corresponding communication port.

9. A network testing system for performing network simulation tests and traffic tests, the network testing system comprising:
at least one administrative workstation, comprising:
a simulation test controlling module;
a traffic generating parameter designing module; and
a network model designing module for designing the network simulating model, and for transmitting the designed network simulating model;
a network testing apparatus, comprising:
a software module, comprising:
a network simulating database for storing a plurality of network simulating models;
a network protocol database for storing a plurality of network protocols;
a simulation processing module; and
a traffic generation controlling module;
a hardware module, comprising:
a traffic generating apparatus; and
a media access control; and
a plurality of communication ports; and
at least one network device connected to the network testing apparatus.

10. The network testing system of claim 9, wherein the at least one administrative workstation is connected to the network testing apparatus through a network.

11. The network testing system of claim 9, wherein the at least one administrative workstation is connected to the network testing apparatus directly.

12. The network testing system of claim 9, wherein when the network testing apparatus is in the network simulating test mode, the simulation test controlling module is for selecting simulation test parameters, and for transmitting the simulation test parameters to the network testing apparatus.

13. The network testing system of claim 12, wherein the simulation processing module is for receiving the simulation test parameters, for selecting a network simulating model and a network protocol according to the simulation test parameters, and for generating a first traffic generating command to control traffic generation of the traffic generating apparatus for performing network simulation tests.

14. The network testing system of claim 12, wherein the simulation test parameters comprises the network simulating model, the network protocol, and the first traffic generating parameters.

15. The network testing system of claim 9, wherein when the network testing apparatus is in the traffic generator operating mode, the traffic generating parameter designing module is for inputting the second traffic generating parameters, and for transmitting the second traffic generating parameters to the network testing apparatus.

16. The network testing system of claim 15, wherein the traffic generation controlling module is for receiving the second traffic generating parameters, and for generating a second traffic generating command to control traffic generation of the traffic generating apparatus for performing traffic tests according to the second traffic generating parameters.

17. The network testing system of claim 15, wherein the second traffic generating parameters comprise traffic rate, packet content and packet length.

18. A network testing method for performing either network simulation tests or traffic tests by using a network testing apparatus, the network testing method comprising the steps of:
a) setting the network testing apparatus in a network simulating test mode or a traffic generator operating mode;
b) when the network testing apparatus is set in the network simulating test mode:
b1) setting simulation test parameters, and transmitting the simulation test parameters to the network testing apparatus; and
b2) receiving the simulation test parameters, selecting a network simulating model and a network protocol according to the simulation test parameters, and controlling traffic generation to perform network simulation tests.

19. The network testing method of claim 18, further includes a step of:
c) when the network testing apparatus is set in the traffic generator operating mode:
c1) setting second traffic generating parameters; and
c2) receiving the second traffic generating parameters, and controlling traffic generation to perform traffic tests according to the second traffic generating parameters.

20. The network testing method of claim 18, wherein step b) further comprises the steps of:
designing the network simulating model;
transmitting the designed network simulating model to the network testing apparatus; and
storing the network simulating model in a network simulating database.

21. The network testing method of claim 18, wherein the network testing apparatus is communicatively located between a tested equipment and a network which said tested equipment is connected to.
